(19) United States
(12) Patent Application Publication
(10) Pub. No.: US 2014/0247365 A1
(43) Pub. Date: Sep. 4, 2014

(54) TECHNIQUES FOR SELECTIVE NOISE REDUCTION AND IMAGING SYSTEM CHARACTERIZATION

(71) Applicant: FLIR Systems, Inc., Wilsonville, OR (US)

(72) Inventors: David W. Gardner, Colorado Springs, CO (US); Nicholas Högasten, Santa Barbara, CA (US)

(73) Assignee: FLIR Systems, Inc., Wilsonville, OR (US)

(21) Appl. No.: 14/052,631

(22) Filed: Oct. 11, 2013

Related U.S. Application Data
(63) Continuation of application No. PCT/US12/32936, filed on Apr. 10, 2012.
(60) Provisional application No. 61/474,199, filed on Apr. 11, 2011.

(51) Int. Cl. G06T 5/00; H04N 5/33; H04N 17/00

(52) U.S. Cl. CPC G06T 5/002; H04N 17/002; H04N 5/33
USPC 348/165; 382/260; 348/241; 348/187

(57) ABSTRACT

Various techniques are disclosed for reducing spatial and temporal noise in captured images. In one example, temporal noise may be filtered while still retaining temporal responsivity in filtered images to allow low contrast temporal events to be captured. Spatial and temporal noise filters may be selectively weighted to more strongly favor filtering using whichever one of the filters is least likely to cause a loss of signal fidelity in actual scene content. Other techniques are disclosed for determining various parameters of imaging systems having image lag. For example, a mean-variance characterization and a noise equivalent irradiance characterization may be performed to determine parameters of the imaging systems. Results of such characterizations may be used to determine the actual performance of the imaging systems without the effects of image lag.

### CROSS REFERENCE TO RELATED APPLICATIONS

This application is a continuation of International Patent Application No. PCT/US12/032,936 filed Apr. 10, 2012, which claims the benefit of U.S. Provisional Patent Application No. 61/474,199 filed Apr. 11, 2011, which are both incorporated herein by reference in their entirety.

### TECHNICAL FIELD

One or more embodiments of the invention relate generally to image processing and more particularly, for example, to providing low noise images with selectable image lag or assessing the performance of imaging systems that may utilize an image lag technique.

### BACKGROUND

Various sources of signal degradation may cause spatial noise or temporal noise to be exhibited in images provided by imaging systems. Spatial noise may be associated with particular locations (e.g., rows and columns) on images and may exhibit changes in magnitude at a significantly slower rate than the rate at which scene information is captured. For example, the spatial noise exhibited in a particular image may be substantially similar to the spatial noise exhibited in the next image (e.g., similar noise may appear at the same or similar rows and columns).

Temporal noise may be substantially uncorrelated over time. In this regard, the temporal noise exhibited in a particular image may be substantially different from the temporal noise, if any, exhibited in the next image (e.g., different noise or no noise may appear at the same or similar rows and columns). In particular, high levels of temporal noise may make temporal changes (e.g., a faint object appearing in a scene) difficult to detect in images.

Unfortunately, noise reduction techniques applied by various existing imaging systems may significantly obscure or eliminate desirable temporal image data. For example, certain noise reduction techniques may introduce significant image lag which may reduce the usefulness of the filtered images for dynamically changing scenes. As another example, finite impulse response (FIR) filters may be used that require many images to be stored while still introducing image lag.

Other noise reduction techniques may attempt to compensate for changes in detected images due to changes in scenes or the motion of an image detector. However, such techniques typically rely on precise estimates of motion that may be prone to error and may require complex logic. Accordingly, there is a need for improved noise reduction techniques for captured images.

In addition, many existing imaging systems may perform temporal filtering which may result in image lag. Such image lag may mask underlying performance parameters of these imaging systems, especially when the temporal filtering and resulting image lag cannot be disabled. Accordingly, there is also a need for improved techniques for evaluating the performance of imaging systems.

### SUMMARY

Various techniques are disclosed for reducing spatial and temporal noise in captured images. In one embodiment, temporal noise may be filtered while still retaining temporal responsivity in filtered images to allow low contrast temporal events to be captured. For example, spatial and temporal noise filters may perform parallel filtering of images. The filters may be selectively weighted to more strongly favor filtering using whichever one of the filters is least likely to cause a loss of signal fidelity in actual scene content. A locally adaptive weighting process may be used to provide a combined filtered result image that exhibits reduced temporal noise and still preserves very low contrast scene changes.

In another embodiment, various techniques may be used to determine various parameters of an imaging system having image lag. For example, a mean-variance characterization and a noise equivalent irradiance characterization may be performed to determine parameters of the imaging system. Results of such characterizations may be used to determine the actual performance of the imaging system without the effects of image lag (e.g., temporal filtering).

In one embodiment, a method of performing noise reduction includes receiving a current image of a scene; comparing the current image and a previously filtered image of the scene to provide a determination of whether the scene is substantially static or substantially dynamic; selectively applying a temporal filter based on the determination to reduce temporal noise in the current and the previously filtered images; selectively applying a spatial filter based on the determination to reduce the temporal noise in the current image; and providing a result image in response to the temporal filter and the spatial filter.

In another embodiment, an imaging system includes an image detector adapted to capture images of a scene; and a processing component adapted to execute a plurality of instructions to: compare a current one of the images and a previously filtered one of the images to provide a determination of whether the scene is substantially static or substantially dynamic, selectively apply a temporal filter based on the determination to reduce temporal noise in the current and the previously filtered images, selectively apply a spatial filter based on the determination to reduce the temporal noise in the current image, and provide a result image in response to the temporal filter and the spatial filter.

In another embodiment, a method of assessing performance of an imaging system, wherein the imaging system performs temporal filtering and exhibits associated image lag, includes performing a mean-variance curve characterization of the imaging system to determine a first system gain; performing a noise equivalent irradiance (NEI) characterization of the imaging system to determine a second system gain; and determining an actual noise value of the imaging system based on the first and second system gains, wherein the actual noise value is not reduced by the temporal filtering performed by the imaging system.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates a block diagram of an imaging system in accordance with an embodiment of the disclosure.

FIG. 2 illustrates a process of providing images with reduced noise in accordance with an embodiment of the disclosure.

FIG. 3 illustrates pixels of a image in accordance with an embodiment of the disclosure.

FIG. 4 illustrates temporal filter weight values stored in a look up table (LUT) in accordance with an embodiment of the disclosure.

FIG. 5 illustrates a process of performing a mean-variance characterization of an imaging system in accordance with an embodiment of the disclosure.

FIG. 6 illustrates a process of performing a noise equivalent irradiance (NEI) characterization of an imaging system in accordance with an embodiment of the disclosure.

FIG. 7 illustrates a process of performing a composite characterization of an imaging system in accordance with an embodiment of the disclosure.

Embodiments of the invention and their advantages are best understood by referring to the detailed description that follows. It should be appreciated that like reference numerals are used to identify like elements illustrated in one or more of the figures.

### DETAILED DESCRIPTION

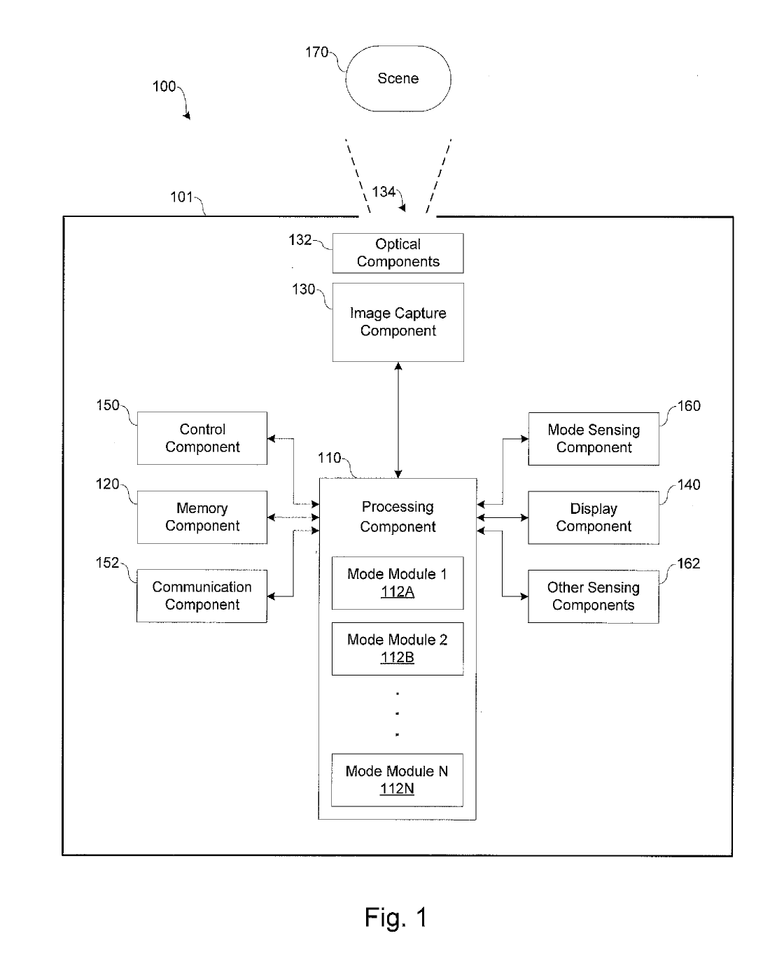

FIG. 1 illustrates a block diagram of an imaging system 100 in accordance with an embodiment of the disclosure. Imaging system 100 may be used to capture and process images in accordance with various techniques described herein. As shown, various components of imaging system 100 may be provided in a housing 101, such as a housing of a camera or other system. In one embodiment, imaging system 100 includes a processing component 110, a memory component 120, an image capture component 130 (e.g., an imager array including a plurality of sensors), optical components 132 (e.g., one or more lenses configured to receive electromagnetic radiation through an aperture 134 in housing 101 and pass the electromagnetic radiation to image capture component 130), a display component 140, a control component 150, and a mode sensing component 160. In another embodiment, imaging system 100 may also include a communication component 152 and one or more other sensing components 162.

In various embodiments, imaging system 100 may represent an imaging device, such as a camera, to capture images, for example, of a scene 170 (e.g., a field of view). Imaging system 100 may represent any type of camera system which, for example, detects electromagnetic radiation and provides representative data (e.g., one or more still images or video images). For example, imaging system 100 may represent a camera that is directed to detect one or more ranges of electromagnetic radiation and provide associated image data. Imaging system 100 may include a portable device and may be implemented, for example, as a handheld device and/or coupled, in other examples, to various types of vehicles (e.g., a land-based vehicle, a watercraft, an aircraft, a spacecraft, or other vehicle) or to various types of fixed locations (e.g., a home security mount, a campsite or outdoors mount, or other location) via one or more types of mounts. In still another example, imaging system 100 may be integrated as part of a non-mobile installation to provide images to be stored and/or displayed.

Processing component 110 may include, for example, a microprocessor, a single-core processor, a multi-core processor, a microcontroller, a logic device (e.g., a programmable logic device configured to perform processing functions), a digital signal processing (DSP) device, one or more memories for storing executable instructions (e.g., software, firmware, or other instructions), and/or or any other appropriate combination of processing device and/or memory to execute instructions to perform any of the various operations described herein. Processing component 110 is adapted to interface and communicate with components 120, 130, 140, 150, 160, and 162 to perform method and processing steps as described herein. Processing component 110 may include one or more mode modules 112A-112N for operating in one or more modes of operation (e.g., to operate in accordance with any of the various embodiments disclosed herein). In one aspect, mode modules 112A-112N are adapted to define preset processing and/or display functions that may be embedded in processing component 110 or stored on memory component 120 for access and execution by processing component 110. In another aspect, processing component 110 may be adapted to perform various types of image processing algorithms as described herein.

In various embodiments, it should be appreciated that each mode module 112A-112N may be integrated in software and/or hardware as part of processing component 110, or code (e.g., software or configuration data) for each mode of operation associated with each mode module 112A-112N, which may be stored in memory component 120. Embodiments of mode modules 112A-112N (i.e., modes of operation) disclosed herein may be stored by a separate machine readable medium (e.g., a memory, such as a hard drive, a compact disk, a digital video disk, or a flash memory) to be executed by a computer (e.g., logic or processor-based system) to perform various methods disclosed herein.

In one example, the machine readable medium may be portable and/or located separate from imaging system 100, with stored mode modules 112A-112N provided to imaging system 100 by coupling the machine readable medium to imaging system 100 and/or by imaging system 100 downloading (e.g., via a wired or wireless link) the mode modules 112A-112N from the machine readable medium (e.g., containing the non-transitory information). In various embodiments, as described herein, mode modules 112A-112N provide for improved camera processing techniques for real time applications, wherein a user or operator may change the mode of operation depending on a particular application, such as a off-road application, a maritime application, an aircraft application, a space application, or other application.

Memory component 120 includes, in one embodiment, one or more memory devices (e.g., one or more memories) to store data and information. The one or more memory devices may include various types of memory including volatile and non-volatile memory devices, such as RAM (Random Access Memory), ROM (Read-Only Memory), EEPROM (Electrically-Erasable Read-Only Memory), flash memory, or other types of memory. In one embodiment, processing component 110 is adapted to execute software stored in memory component 120 to perform various methods, processes, and modes of operations in manner as described herein.

Image capture component 130 includes, in one embodiment, one or more sensors (e.g., any type visible light, infrared, or other type of detector, including a detector forming a focal plane array) for capturing image signals representative of an image, of scene 170. In one embodiment, the sensors of image capture component 130 provide for representing (e.g., converting) a captured image signal of scene 170 as digital data (e.g., via an analog-to-digital converter included as part of the sensor or separate from the sensor as part of imaging system 100). Processing component 110 may be adapted to receive image signals from image capture component 130, process image signals (e.g., to provide processed image data), store image signals or image data in memory component 120, and/or retrieve stored image signals from memory component 120. Processing component 110 may be adapted to process image signals stored in memory component 120 to provide image data (e.g., captured and/or processed image data) to display component 140 for viewing by a user.

Display component 140 includes, in one embodiment, an image display device (e.g., a liquid crystal display (LCD)) or various other types of generally known video displays or monitors. Processing component 110 may be adapted to display image data and information on display component 140. Processing component 110 may be adapted to retrieve image data and information from memory component 120 and display any retrieved image data and information on display component 140. Display component 140 may include display electronics, which may be utilized by processing component 110 to display image data and information. Display component 140 may receive image data and information directly from image capture component 130 via processing component 110, or the image data and information may be transferred from memory component 120 via processing component 110.

In one embodiment, processing component 110 may initially process a captured image and present a processed image in one mode, corresponding to mode modules 112A-112N, and then upon user input to control component 150, processing component 110 may switch the current mode to a different mode for viewing the processed image on display component 140 in the different mode. This switching may be referred to as applying the camera processing techniques of mode modules 112A-112N for real time applications, wherein a user or operator may change the mode while viewing an image on display component 140 based on user input to control component 150. In various aspects, display component 140 may be remotely positioned, and processing component 110 may be adapted to remotely display image data and information on display component 140 via wired or wireless communication with display component 140, as described herein.

Control component 150 includes, in one embodiment, a user input and/or interface device having one or more user actuated components, such as one or more push buttons, slide bars, rotatable knobs or a keyboard, that are adapted to generate one or more user actuated input control signals. Control component 150 may be adapted to be integrated as part of display component 140 to function as both a user input device and a display device, such as, for example, a touch screen device adapted to receive input signals from a user touching different parts of the display screen. Processing component 110 may be adapted to sense control input signals from control component 150 and respond to any sensed control input signals received therefrom.

Control component 150 may include, in one embodiment, a control panel unit (e.g., a wired or wireless handheld control unit) having one or more user-activated mechanisms (e.g., buttons, knobs, sliders, or others) adapted to interface with a user and receive user input control signals. In various embodiments, the one or more user-activated mechanisms of the control panel unit may be utilized to select between the various modes of operation, as described herein in reference to mode modules 112A-112N. In other embodiments, it should be appreciated that the control panel unit may be adapted to include one or more other user-activated mechanisms to provide various other control functions of imaging system 100, such as auto-focus, menu enable and selection, field of view (FoV), brightness, contrast, gain, offset, spatial, temporal, and/or various other features and/or parameters. In still other embodiments, a variable gain signal may be adjusted by the user or operator based on a selected mode of operation.

In another embodiment, control component 150 may include a graphical user interface (GUI), which may be integrated as part of display component 140 (e.g., a user actuated touch screen), having one or more images of the user-activated mechanisms (e.g., buttons, knobs, sliders, or others), which are adapted to interface with a user and receive user input control signals via the display component 140. As an example for one or more embodiments as discussed further herein, display component 140 and control component 150 may represent a smart phone, a tablet, a personal digital assistant (e.g., a wireless, mobile device), a laptop computer, a desktop computer, or other type of device.

Mode sensing component 160 includes, in one embodiment, an application sensor adapted to automatically sense a mode of operation, depending on the sensed application (e.g., intended use or implementation), and provide related information to processing component 110. In various embodiments, the application sensor may include a mechanical triggering mechanism (e.g., a clamp, clip, hook, switch, push-button, or others), an electronic triggering mechanism (e.g., an electronic switch, push-button, electrical signal, electrical connection, or others), an electro-mechanical triggering mechanism, an electro-magnetic triggering mechanism, or some combination thereof. For example for one or more embodiments, mode sensing component 160 senses a mode of operation corresponding to the imaging system's 100 intended application based on the type of mount (e.g., accessory or fixture) to which a user has coupled the imaging system 100 (e.g., image capture component 130). Alternatively, the mode of operation may be provided via control component 150 by a user of imaging system 100 (e.g., wirelessly via display component 140 having a touch screen or other user input representing control component 150).

Furthermore in accordance with one or more embodiments, a default mode of operation may be provided, such as for example when mode sensing component 160 does not sense a particular mode of operation (e.g., no mount sensed or user selection provided). For example, imaging system 100 may be used in a freeform mode (e.g., handheld with no mount) and the default mode of operation may be set to handheld operation, with the images provided wirelessly to a wireless display (e.g., another handheld device with a display, such as a smart phone, or to a vehicle's display).

Mode sensing component 160, in one embodiment, may include a mechanical locking mechanism adapted to secure the imaging system 100 to a vehicle or part thereof and may include a sensor adapted to provide a sensing signal to processing component 110 when the imaging system 100 is mounted and/or secured to the vehicle. Mode sensing component 160, in one embodiment, may be adapted to receive an electrical signal and/or sense an electrical connection type and/or mechanical mount type and provide a sensing signal to processing component 110. Alternatively or in addition, as discussed herein for one or more embodiments, a user may provide a user input via control component 150 (e.g., a wireless touch screen of display component 140) to designate the desired mode (e.g., application) of imaging system 100.

Processing component 110 may be adapted to communicate with mode sensing component 160 (e.g., by receiving sensor information from mode sensing component 160) and image capture component 130 (e.g., by receiving data and information from image capture component 130 and providing and/or receiving command, control, and/or other information to and/or from other components of imaging system 100).

In various embodiments, mode sensing component 160 may be adapted to provide data and information relating to system applications including a handheld implementation and/or coupling implementation associated with various types of vehicles (e.g., a land-based vehicle, a watercraft, an aircraft, a spacecraft, or other vehicle) or stationary applications (e.g., a fixed location, such as on a structure). In one embodiment, mode sensing component 160 may include communication devices that relay information to processing component 110 via wireless communication. For example, mode sensing component 160 may be adapted to receive and/or provide information through a satellite, through a local broadcast transmission (e.g., radio frequency), through a mobile or cellular network and/or through information beacons in an infrastructure (e.g., a transportation or highway information beacon infrastructure) or various other wired or wireless techniques (e.g., using various local area or wide area wireless standards).

In another embodiment, imaging system 100 may include one or more other types of sensing components 162, including environmental and/or operational sensors, depending on the sensed application or implementation, which provide information to processing component 110 (e.g., by receiving sensor information from each sensing component 162). In various embodiments, other sensing components 162 may be adapted to provide data and information related to environmental conditions, such as internal and/or external temperature conditions, lighting conditions (e.g., day, night, dusk, and/or dawn), humidity levels, specific weather conditions (e.g., sun, rain, and/or snow), distance (e.g., laser rangefinder), and/or whether a tunnel, a covered parking garage, or that some type of enclosure has been entered or exited. Accordingly, other sensing components 160 may include one or more conventional sensors as would be known by those skilled in the art for monitoring various conditions (e.g., environmental conditions) that may have an affect (e.g., on the image appearance) on the data provided by image capture component 130.

In some embodiments, other sensing components 162 may include devices that relay information to processing component 110 via wireless communication. For example, each sensing component 162 may be adapted to receive information from a satellite, through a local broadcast (e.g., radio frequency) transmission, through a mobile or cellular network and/or through information beacons in an infrastructure (e.g., a transportation or highway information beacon infrastructure) or various other wired or wireless techniques.

In various embodiments, components of imaging system 100 may be combined and/or implemented or not, as desired or depending on application requirements, with imaging system 100 representing various functional blocks of a system. For example, processing component 110 may be combined with memory component 120, image capture component 130, display component 140, and/or mode sensing component 160. In another example, processing component 110 may be combined with image capture component 130 with only certain functions of processing component 110 performed by circuitry (e.g., a processor, a microprocessor, a microcontroller, a logic device, or other circuitry) within image capture component 130. In still another example, control component 150 may be combined with one or more other components or be remotely connected to at least one other component, such as processing component 110, via a wired or wireless control device so as to provide control signals thereto.

In one embodiment, imaging system 100, may include a communication component 152, such as a network interface component (NIC) adapted for communication with a network including other devices in the network. In various embodiments, communication component 152 may include a wireless communication component, such as a wireless local area network (WLAN) component based on the IEEE 802.11 standards, a wireless broadband component, mobile cellular component, a wireless satellite component, or various other types of wireless communication components including radio frequency (RF), microwave frequency (MWF), and/or infrared frequency (IRF) components adapted for communication with a network. As such, communication component 152 may include an antenna coupled thereto for wireless communication purposes. In other embodiments, the communication component 152 may be adapted to interface with a DSL (e.g., Digital Subscriber Line) modem, a PSTN (Public Switched Telephone Network) modem, an Ethernet device, and/or various other types of wired and/or wireless network communication devices adapted for communication with a network.

In various embodiments, a network may be implemented as a single network or a combination of multiple networks. For example, in various embodiments, the network may include the Internet and/or one or more intranets, landline networks, wireless networks, and/or other appropriate types of communication networks. In another example, the network may include a wireless telecommunications network (e.g., cellular phone network) adapted to communicate with other communication networks, such as the Internet. As such, in various embodiments, the imaging system 100 may be associated with a particular network link such as for example a URL (Uniform Resource Locator), an IP (Internet Protocol) address, and/or a mobile phone number.

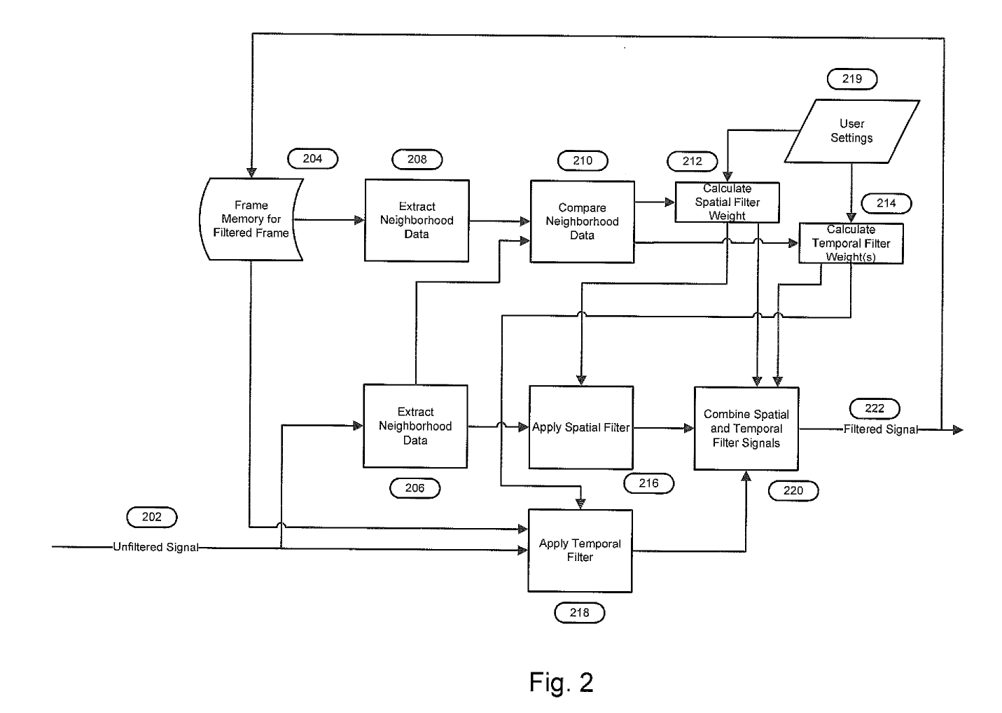

In various embodiments, imaging system 100 may selectively apply spatial and/or temporal filtering to images of scene 170 that are detected (e.g., captured) by image capture component 130. FIG. 2 illustrates a process of providing images with reduced noise that may be performed by imaging system 100 in accordance with an embodiment of the disclosure. For example, in one embodiment, the process of FIG. 2 may be performed by processing component 110 and memory component 120 of imaging system 100. In various embodiments, the process of FIG. 2 may provide a robust, computationally efficient approach to reducing temporal noise regardless of imaging conditions. For example, the process of FIG. 2 may be performed in realtime as images (e.g., image frames) are captured by image capture component 130.

In the process of FIG. 2, spatial filtering and/or temporal filtering may be selectively applied to various portions of a captured image. Such filtering may be weighted based on various user settings as well as a comparison between neighborhoods of pixels of a current image and a previously filtered image.

For example, the process of FIG. 2 may determine whether scene 170 is relatively static (e.g., unchanging over time) or dynamic (e.g., changing over time) based on a comparison (block 210) between pixels of successive images. If scene 170 is determined to be static, then a temporal filter 218 (e.g., an infinite impulse response (IIR) filter in one embodiment) may be applied to remove temporal noise (e.g., noise that changes between different images). On the other hand, if scene 170 is determined to be dynamic, then a spatial filter 216 may be applied to remove the temporal noise.

As a result, the level of noise exhibited in filtered result images provided by imaging system 100 may remain substantially constant, regardless of whether scene 170 is static or dynamic. For example, averaging over time (e.g., temporal filtering) and averaging over space (e.g., spatial filtering) may both be used (e.g., separately or together) to reduce temporal noise in cases where temporal noise is not correlated in either space or time.

In one embodiment, temporal filter 218 may be used instead of spatial filter 216 when scene 170 is static in order to avoid possible loss of resolution associated with spatial filtering. In one embodiment, spatial filter 216 may be used as a backup filter to temporal filter 218 when scene 170 is detected to be dynamic. In one embodiment, temporal filter 218 and spatial filter 216 may operate in parallel.

The temporal filter 218 and spatial filter 216 may be weighted to selectively apply more or less temporal or spatial filtering to images. For example, the application of such filtering may be adjusted based on spatial filter weights and temporal filter weights. Such weights may be provided (e.g., calculated or otherwise determined) based on user settings 219, comparisons performed in block 210 to determine whether temporal changes exhibited by pixels of successive images may be attributed to actual changes in scene 170 or temporal noise (e.g., by comparing neighborhoods of pixels), and/or other processes.

Advantageously, by strongly weighting spatial filter 216 and weakly weighting temporal filter 218 during dynamic changes in scene 170, imaging system 100 may avoid motion blur and image lag (e.g., persistence) that may be attributable to temporal filtering. Conversely, by weakly weighting spatial filter 216 and strongly weighting temporal filter 218 while scene 170 is static, imaging system 100 may achieve substantial reduction of zero mean temporal noise while avoiding some resolution loss (e.g., image blur) that may be attributable to spatial filtering.

Turning now to further details of the process of FIG. 2, signals associated with individual sensors of image capture component 130 may be received from image capture component 130 as unfiltered signals 202. In this regard, each unfiltered signal 202 may correspond to a data value for a pixel (e.g., a pixel value) of a captured image taken of scene 170. Accordingly, if image capture component 130 is implemented with M rows and N columns of sensors, then M×N unfiltered signals 202 may be provided for each image.

In block 204, a previously filtered image is stored, for example, in memory component 120 of imaging system 100. In one embodiment, the previously filtered image may be the final pixel values determined and provided as filtered signals 222 in a previous iteration of the process of FIG. 2.

In block 206, for each pixel in the current image provided by unfiltered signals 202, pixel values of neighboring pixels may be extracted (e.g., identified or determined). For example, in one embodiment, pixel values of the two closest neighboring pixels in each direction may be extracted. Similarly, in block 208, for each pixel in the previously filtered image stored in block 204, pixel values of neighboring pixels may be extracted.

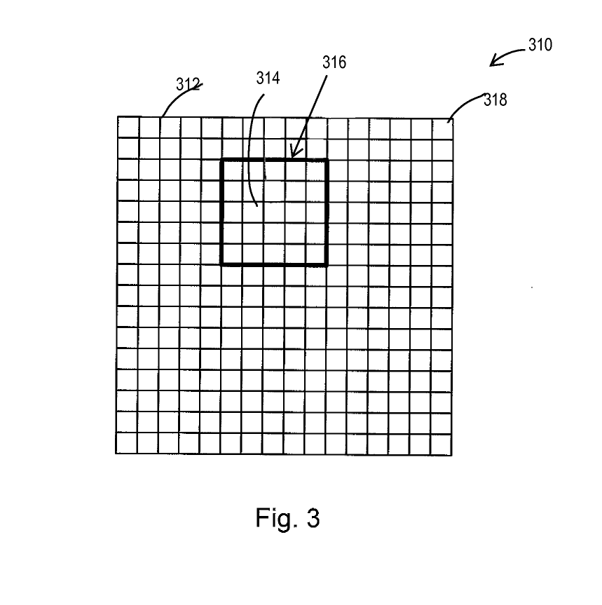

FIG. 3 illustrates pixels 312 of an image 310 in accordance with an embodiment of the disclosure. As shown, image 310 includes pixels 312 arranged in 16 rows and 16 columns. Although only a small number of rows and columns are illustrated in FIG. 3, any desired number of rows and columns may be provided. One of pixels 312 is identified as pixel 314 within a neighborhood 316.

In the example shown in FIG. 3, neighborhood 316 includes the two pixels 312 closest to pixel 314 in each direction. Therefore, in this example, the pixel values of all pixels 312 in neighborhood 316 may be extracted for pixel 314 in block 206 for a total of 25 pixel values in this example. In other embodiments, different or varying neighborhood sizes may be used. In one embodiment, for pixels 312 lacking at least two neighbors in each direction (e.g., a pixel 318), fewer neighboring pixel values may be used.

The operation of block 206 may be performed for all pixels of the current image such that a set of extracted neighboring pixel values may be provided for each pixel. Similarly, the operation of block 208 may be performed for all pixels of the previous filtered image. Thus, a set of neighboring pixel values may be determined for all pixels of the current image (e.g., extracted in block 206 for the current image provided by unfiltered signals 202) and for all pixels of the previous filtered image (e.g., extracted in block 208 for the previous filtered image provided by filtered signals 222 and stored in block 204).

In block 210, the extracted neighborhood pixel values are compared for corresponding pixels in the current image and the previous filtered image. For example, in the case of pixel 314, the pixel values in neighborhood 316 of the current image may be compared with the pixel values in a corresponding neighborhood of the previous filtered image.

In various embodiments, different types of comparisons may be performed in block 210. In one embodiment, pairwise differences between the pixel values of corresponding pixels in the current and filtered neighborhoods may be determined and summed together to provide a comparison value. For example, for a neighborhood of two neighboring pixels (e.g., neighborhood 316), 25 differences may be determined and summed. By performing such comparisons for the neighborhood of each pixel, a comparison value may be determined for each pixel (e.g., if the current and filtered images each include M×N pixels, then a total of M×N comparison values may be determined in block 210).

If images provided by image capture component 130 are substantially static (e.g., if scene 170 remains substantially unchanged and image capture component 130 is not in motion) and if the noise in the current and filtered images is substantially attributable to zero mean temporal noise, then it may be expected that the sum of the pairwise differences may be close to zero. On the other hand, if image frames provided by image capture component 130 are not substantially static (e.g., if scene 170 changes or image capture component 130 is in motion), then it may be expected that the sum of the pairwise differences may not be close to zero. Thus, the sum of the pairwise differences may be used to determine whether temporal changes in successive images are attributable to zero mean temporal noise or actual changes in captured changes (e.g., due to changes in scene 170 or motion of image capture component 130).

In other embodiments, other comparisons may be performed in block 210. In one embodiment, a maximum difference measurement may be performed and used along with the sum of pairwise differences previously discussed. In this regard, for corresponding neighborhoods in current and filtered images, a maximum difference between corresponding pixels in the neighborhoods may be determined. Such a maximum difference measure may be used to detect large pixel value changes within a neighborhood that may otherwise happen to sum up to a zero mean change when pairwise differences are summed.

A large maximum difference value may indicate actual changes in scene 170 or motion of image capture component 130 which result in temporal changes in neighborhood 316. Strong temporal damping may otherwise delay detection of such changes. Accordingly, the identification of a maximum difference value for each neighborhood may improve the accuracy of temporal change detection over embodiments using only sums of pairwise differences.

Comparison results (e.g., comparison values) determined in block 210 may be provided to blocks 212 and 214. In block 212, one or more spatial filter weights may be calculated in response to the comparison results and user settings 219. In block 214, one or more temporal filter weights may be calculated in response to the comparison results and user settings 219.

User settings 219 may be used to apply spatial or temporal filtering more or less aggressively, or not at all. In this regard, user settings 219 may permit spatial and temporal filtering to be programmable. For example, user settings 219 may scale the spatial and temporal filter weights applied to spatial filter 216 and temporal filter 218 to any desired extent.

In one embodiment, a user may desire to disable one or both of filters 216 and 218. For example, a user may select appropriate user settings 219 to partially or completely disable temporal filter 218 to prevent image lag from being exhibited by filtered signals 222 that might be attributable to temporal filtering (e.g., to prevent image data of previous images from contributing to filtered signals 222). In another example, a user may select appropriate user settings 219 to partially or completely disable spatial filter 216 to prevent image blur from being exhibited by filtered signals 222 that might be attributable to spatial filtering (e.g., to prevent possible loss of resolution which may be caused by spatial filtering). In yet another example, a user may select appropriate user settings 219 to selectively apply any desired amount of either, both, or neither filter (e.g., to apply very little noise reduction to reduce the possibility of filtering out non-noise portions of the images and/or to prevent image lag).

In another embodiment, imaging system 100 may not use user settings 219, but may instead perform a process to determine the current noise level of imaging system 100 and adjust the spatial and temporal filter weights based on a detected noise level. In another embodiment, the temporal filter weights and/or the spatial filter weights may be determined without the results provided by block 210.

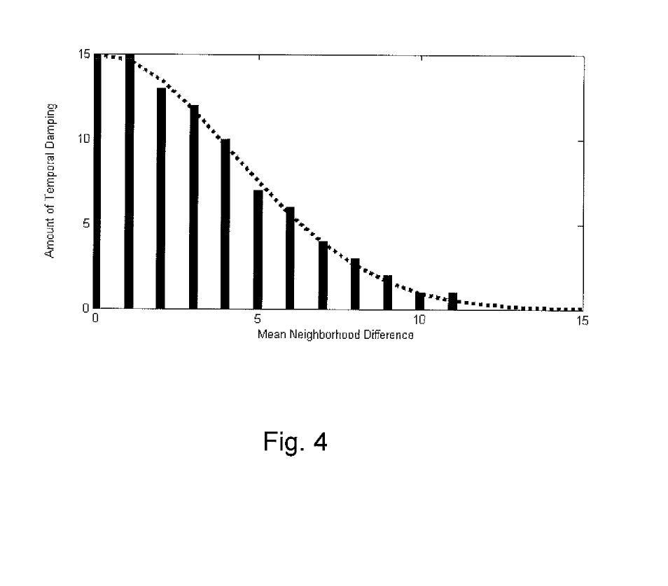

In one embodiment, the spatial and temporal filter weights may be calculated in blocks 212 and 214 using one or more lookup tables (LUTs). For example, FIG. 4 illustrates temporal filter weight values stored in a LUT in accordance with an embodiment of the disclosure. In one embodiment, such a LUT may be provided in memory component 120 of imaging system 100. As shown in FIG. 4, a temporal filter weight (e.g., damping weight) in the range of 0 to 15 may be provided based on the comparison results provided by block 210. For example, the comparison results may be used as the address input to the LUT to retrieve corresponding temporal damping weight values.

In FIG. 4, the comparison results are provided as a mean neighborhood difference (e.g., the mean of all sums of pairwise differences for all neighborhoods). In this regard, for large mean neighborhood differences (e.g., indicating that scene 170 may be changing dynamically), small temporal damping weights may be used (e.g., to weakly weight temporal filter 218 to avoid motion blur and image lag that may be attributable to temporal filtering). Conversely, for small mean neighborhood differences (e.g., indicating that scene 170 may be relatively static), large temporal damping weights may be used (e.g., to strongly weight temporal filter 218 to reduce zero mean temporal noise). In one embodiment, temporal damping weight values stored by the LUT may approximate a Gaussian distribution.

Spatial filter weights may be determined using another LUT if desired. For example, in one embodiment, spatial filter weights may exhibit an inverse distribution from that shown in FIG. 3 for temporal filter weights.

In one embodiment, for a given size of neighborhood 316, the maximum reduction of temporal noise (e.g., measured as standard deviation) may be proportional to the number of samples (e.g., pixel values) in neighborhood 316. To avoid blurring of sharp edges in an image, spatial filter 216 may be a shape adaptive spatial filter.

In one embodiment, spatial filter 216 may be a non-linear and adaptive bilateral filter used to perform edge preserving filtering. In one embodiment, the amount of noise reduction achieved through spatial filtering may be increased or decreased by adjusting the size of spatial filter 216 or adjusting the weights attributed to neighboring pixels by spatial filter 216.

In one embodiment, shape adaptive weights may be convolved with a Gaussian kernel of variance that is inversely proportional to that of a temporal damping factor. Such an embodiment may increase spatial smoothing to compensate for possible increases in temporal noise when temporal filtering decreases.

In various embodiments, depending on the size of aperture 134 provided to optical components 132, the wavelength of electromagnetic radiation detected by image capture component 130, and the dimensions of sensors of image capture component 130, it may be unlikely for a single pixel to exhibit a change in response to scene 170 without neighboring pixels also exhibiting a change. In particular, when imaging mid and long wave infrared wave bands (MWIR and LWIR), imaging system 100 may be diffraction limited by aperture 134 and optical components 132. As a result, a point source in scene 170 is likely to affect neighbor sensor elements when imaging in the MWIR to LWIR wave bands.

Accordingly, in one embodiment, block 210 may include comparing each pixel (e.g., pixel 314) with neighboring pixels (e.g., other pixels 312 in neighborhood 316 of the same image) to determine the differences in pixel values. In this case, the comparison results provided by block 210 may be used to distinguish between high amplitude noise (e.g., which may affect individual pixels but not their neighboring pixels) and point source changes in scene 170 (e.g., which may affect individual pixels and their neighboring pixels). Thus, large differences in neighboring pixel values of the same image, or successive images, may indicate the presence of noise rather than actual changes in scene 170 or movement of image capture component 130. In this case, temporal and spatial filter weights may be adjusted in response to such differences (e.g., to apply strong temporal filtering in one embodiment).

In one embodiment, if the results provided by block 210 indicate that scene 170 is changing, then stronger spatial filtering may be applied (e.g., the reach of the spatial filter applied in block 216 may increase) to keep temporal noise constant as temporal filter weights decrease due to the detected temporal changes in scene 170.

The current image encoded in unfiltered signals 202 may be provided to spatial filter 216 and temporal filter 218. In addition, the previous filtered image stored in block 204 may be provided to temporal filter 218.

Spatial filter 216 may perform spatial filtering on the current image to provide a spatially filtered image to block 220. The level (e.g., strength or degree) of filtering performed by spatial filter 216 may be selectively adjusted (e.g., scaled) based on spatial filter weights provided by block 212.

In parallel with spatial filter 216, temporal filter 218 may perform temporal filtering on the current image and the previous filtered image to provide a temporally filtered image to block 220. The level of filtering performed by temporal filter 218 may be selectively adjusted based on temporal filter weights provided by block 214.

In block 220, the spatially filtered image provided by spatial filter 216 and the temporally filtered image provided by temporal filter 218 may be combined to provide a final filtered image (e.g., a filtered result image) encoded in filtered signals 222. The spatially filtered and temporally filtered images may be combined in any desired manner. For example, in one embodiment, corresponding pixel values may be added together and/or weighted in accordance with the spatial and temporal filter weights provided by blocks 212 and 214.

As discussed, the spatial and temporal filter weights may be used to scale the level of spatial and temporal filtering applied. Accordingly, in some cases, the final filtered image may exhibit filtering by only one of filters 216 or 218. In other cases, the final filtered image may exhibit filtering from both of filters 216 or 218 which may be applied to the same or different levels depending on the spatial and temporal filter weights.

Filtered signals 222 may be provided to block 204 to store the final filtered image for use in the next iteration of the process of FIG. 2.

In one embodiment, image capture component 130 may be configured as a multispectral imager (e.g., using one or more detector arrays). In such an embodiment, the process of FIG. 2 may be performed for each detected spectrum (e.g., waveband) with temporal and spatial filters associated with each spectrum. For example, the process of FIG. 2 may be performed for each of red, green, and blue bands of visible light, other bands of infrared radiation, or other bands of electromagnetic radiation.

In accordance with various embodiments described herein, testing methodologies may be used to determine the effects of image lag on imaging characterization and intentional implementation of programmable image lag into imaging systems that may be turned on or off based upon need. For example, such testing methodologies may be used to evaluate imaging systems by determining actual characteristics of imaging systems that may be otherwise distorted or masked by the effects of image lag. The performance of an imaging system that performs temporal filtering and exhibits associated image lag may be assessed. For example, an actual noise value of the imaging system that is not reduced by the temporal filtering may be determined.

As discussed, user settings 219 may be used to program imaging system 100 to apply spatial or temporal filtering more or less aggressively, or not at all. For example, in one embodiment, temporal filtering may be selectively disabled to reduce or prevent image lag in filtered signals 222, and also to permit rapid changes in scene 170 to be captured imaging system 100.

However, many conventional imaging systems may exhibit significant image lag that may not be readily apparent to a user. Indeed, such image lag may be extremely problematic such that rapid changes in a given scene may be blurred or completely undetected.

Image lag is often exhibited by conventional imaging systems implemented to detect electromagnetic radiation in the short wave infrared (SWIR) band (e.g., SWIR cameras or other imaging systems), in contrast with many conventional silicon imagers. For example, image lag may manifest as blurred images or ghost-like artifacts in images. In addition, however, the presence of image lag may affect the manner in which such imaging systems are characterized by manufacturers and perceived by users.

For example, imaging systems with image lag may exhibit various characterization parameters that may be distorted or masked. Such parameters may include, for example, artificially low noise, artificially high full-well capacity, incorrect system gain calculations, incorrect noise equivalent irradiance, or other parameters.

In this regard, the image provided to a user of such imaging systems may include image data not only from the most recent integration period “T0” (e.g., the most recent image captured by the imaging system), but may also include at least some fraction of the image captured at a prior integration period “T-1” and some smaller fraction of the image captured at another prior integration period “T-2” and so on such that image data from earlier captured images continues to persist in the final images provided to the user.

For imaging systems without image lag, each time-sequential image provided by the system may correspond to a clear captured image (e.g., snapshot) of a scene. In contrast, an image provided by an imaging system exhibiting image lag may be, for example, an arithmetic sum of multiple snapshots of the scene which may result in ghosting or blurring of the scene.

One cause of image lag in SWIR imaging systems may be attributed to some silicon readout integrated circuits (ROICs) in which not all of the captured image charge is read out during a single image frame readout period. Instead, a small fraction of each image may be left as residue (e.g., residual image data) that is retained on the sensors (e.g., InGaAs photodiodes or other types of sensors) after readout is performed. During the next image frame readout period, the current image plus part of that residue is read out. That residue, in turn, may include a portion of an even earlier image and so on. As a result, any given image provided to the user may actually be the sum of the most current image plus a decaying, time-weighted sum of all preceding images. Mathematically, this has the effect of temporally low-pass filtering (e.g., recursive filtering) the final image provided to the user.

Unfortunately, such image lag caused by residual image frames is often a permanent feature in conventional imaging systems. Consequently, the image lag may not be adjusted or disabled in such conventional imaging systems for scenarios where image lag (e.g., temporal filtering) is not needed or wanted. In addition, the underlying cause of such image lag (e.g., residual charge retained by sensors) tends to become more pronounced at higher frame rates (e.g., circumstances in which temporal filtering may be particularly undesirable), and also at low temperatures (e.g., circumstances in which sensors may be cooled to achieve better low-noise performance). As a result, non-adjustable image lag tends to impact images most severely in the worst possible situations.

The ghostly persistence caused by image lag may impact imaging performance in a number of ways. For example, motion in a scene or vibration in the imaging system may result in smearing of all or part of the image and possible loss of fine detail. In other applications, objects such as flashing lights (e.g., identification of friend or foe (IFF) beacons, firefly beacons, runway lights, laser designators, or other lights) may be severely attenuated as their time-varying signature may be suppressed by the temporal low pass filtering nature of image lag.

As discussed, temporal filtering may be used to remove temporal noise in images of scenes that are relatively static (e.g., with no motion, vibration, flashing lights, or other temporal changes). Indeed, in some implementations, such temporal filtering may be used to reduce root mean square (rms) temporal read noise low enough to detect night glow (e.g., which may require less than 10 electrons rms of noise to see).

Night glow is a naturally occurring effect which bathes the earth in electromagnetic radiation even during the night. Hydroxyl ions in the earth's outer atmosphere emit electromagnetic radiation which is well within the SWIR spectral band. The amount of electromagnetic radiation available in this band is nearly an order of magnitude greater than that available from starlight illumination. Unfortunately, the temporal noise floors of many SWIR imaging systems are often 10-20 times too high to detect night glow energy. However, with recursive temporal filtering, temporal noise can be reduced dramatically to the point where night glow imaging is possible for static scenes (e.g., in which image blur from temporal filtering not a problem).

However, despite the advantages of temporal filtering used under certain circumstances, it may not be desirable to perform temporal filtering at all times. Unfortunately, many existing imaging systems apply temporal filtering at all times and may not provide a way to disable temporal filtering. Indeed, such temporal filtering may be intrinsic to the actual design of such existing imaging systems (e.g., the ROICs as discussed or other components). Moreover, such existing imaging systems may not clearly identify how much temporal filtering is being applied. Thus, even if a user desires to know how much temporal filtering is performed, this information may not be available. As a result, the user may be unable to know whether or how much temporal filtering is being performed, or to what extent such temporal filtering may impact the performance of the imaging system.

In accordance with various embodiments, imaging systems with image lag (e.g., solid-state SWIR imaging systems or other systems) may be characterized using several techniques. Such techniques may be performed by one or more appropriate processing components (e.g., local or remote systems) adapted to execute a plurality of instructions to perform the various operations and calculations discussed.

In one embodiment, a mean-variance characterization (e.g., photon transfer curve (PTC) characterization) may be performed to compare the change in mean signal value versus rms noise in images provided by an imaging system to determine system gain, full well capacity, the inherent noise floor of the imaging system, and/or other parameters. In another embodiment, a noise equivalent irradiance (NEI) characterization may be performed to determine the same or similar parameters by observing what mean level of input illumination may be used to substantially equal the rms noise floor of the imaging system in darkness (e.g., NEI may determine the input illumination level used to create a signal to noise ratio (SNR) of 1:1). In another embodiment, parameters determined from the mean-variance characterization and the NEI characterization may be used together to perform a further characterization of an imaging system.

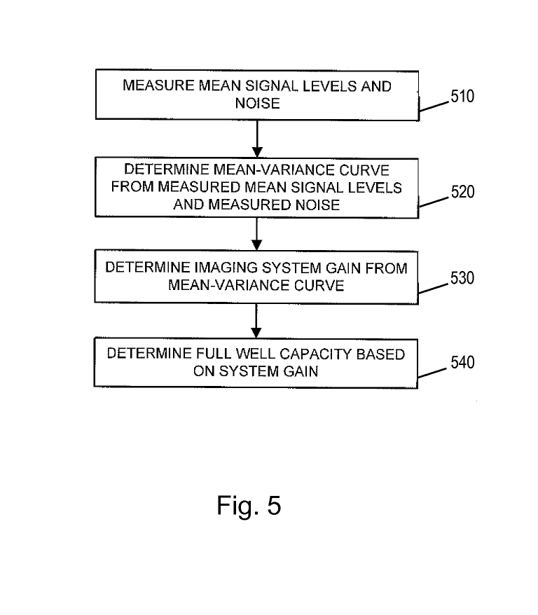

FIG. 5 illustrates a process of performing a mean-variance characterization of an imaging system in accordance with an embodiment of the disclosure. A mean-variance curve (e.g., also referred to as a photon transfer curve) uses the fact that the change in noise occurring in an imaging system in response to increased illumination is due to photon shot noise.

Photon shot noise has the characteristic that the noise variance in electrons (e.g., the square of rms noise) associated with a particular light level is always equal to the mean signal level in electrons at that same light level, and the rms photon shot noise in electrons equals the square root of the mean signal level in electrons. For example, for a transition in mean signal level from total darkness to 10,000 electrons detected on average by each sensor of an imaging system, a corresponding increase of 10,000 electrons in photon shot noise variance may be expected to be present in the image output by the imaging system. Thus, for a photon shot noise limited system, a plot of photon shot noise variance versus mean signal level in electrons may be a straight line with a slope of 1. In practice, signal electrons may be measured indirectly by measuring a change in analog to digital (A/D) units (ADUs) resulting from a change in the electromagnetic radiation received by an imaging system.

In block 510, mean signal levels and noise levels output by an imaging system may be measured (e.g., in ADUs). For example, multiple measurements may be performed under various conditions (e.g., total darkness, low and high levels of received electromagnetic radiation, or other conditions). For example, if the imaging system is implemented as a camera, then the camera may be positioned to detect images under various conditions. In another example, if the imaging system is modular, then the image capture component may be so positioned, while various other components of the imaging system are positioned elsewhere.

In block 520, a mean-variance curve may be determined from the measured mean signal levels and measured noise levels. For example, in one embodiment, a slope of a mean-variance curve may be determined from measurements of the signal and noise levels under at least two conditions.

The change in ADUs associated with different measurements may correlate with the overall gain of the imaging system which may depend upon both on-chip sensor gain and off-chip amplifier gains. When the output of the imaging system is measured in ADUs, the noise variance versus mean curve may no longer exhibit a slope of 1. Instead, the slope of the line may become:

gv/gm

In this case, gv is the gain of the imaging system in terms of noise electrons, and gm is the gain of the imaging system in terms of its mean value of electrons. Under ideal conditions, gv would equal gm², because the variance squares the gain factor, and the slope of the mean-variance curve becomes gm (e.g., the gain of the system in terms of ADUs per electron). Typically, this is inverted and expressed as a system gain Gs (in electrons/ADU).

However, under other conditions, gv may not equal gm². In such cases, the imaging system gain may be different for time-varying (e.g., temporal) noise than it is for a DC change in mean signal value. Such circumstances may occur when image lag is present. In this regard, temporal filtering (e.g., recursive filtering) may operate as a low pass filter to pass the mean image value while suppressing the noise variance to reduce temporal noise. Accordingly, image lag may effectively reduce gv relative to gm. As a result, the slope of the mean-variance curve may be a ratio of two gains gv and gm, where gv no longer equals gm², and the mean-variance slope no longer provides the actual imaging system gain (gm).

The existence of such image lag and recursive filtering may affect the characterization of imaging systems. For example, if an imaging system exhibits image lag and rms noise measured at the system output is artificially attenuated (e.g., by a factor of 2 in one example), a user may not even perceive the attenuation. Rather, the user may just measure a number of rms ADU counts of noise (e.g., 5.675 counts measured in block 510 in one example) and thus may assume the measured number is the noise floor of the imaging system in darkness. Thus, the user may not realize that the actual noise floor would have been 11.35 counts if not for the image lag and recursive filtering which artificially suppressed the noise.

As discussed, the slope of the mean-variance curve may be used to determine the imaging system gain (block 530). In this example, the imaging system may have an actual system gain of 6.2 electrons/ADU. However, because the measured read noise is suppressed by 2 in this example, the mean-variance curve may be artificially reduced by 4 (e.g., as discussed, the mean-variance is the square of the measured rms noise). From the reciprocal of this slope, the measured system gain may be calculated as 24.8 electrons/ADU (e.g., which is 4 times higher than the actual system gain in this example).

Continuing this example, the full well capacity of the imaging system may be determined (block 540) by multiplying the full A/D count range within the linear region by the system gain per ADU. Assuming a 12 bit A/D converter with a 4096 count range, the full well capacity may be calculated as approximately 101,581 electrons (e.g., 4096 counts×24.8 electrons/ADU=101,580.8).

Table 1 below shows a comparison of real values (e.g., actual performance that would have been perceived if image lag was not present) and calculated values (e.g., perceived performance with image lag present) for a mean-variance characterization of an example imaging system as discussed:

TABLE 1

| PARAMETER | REAL VALUE | CALCULATED VALUE |
|---|---|---|
| Read Noise (rms) | 11.35 ADU counts | 5.675 ADU counts |
| System Gain | 6.2 electrons/ADU | 24.4 electrons/ADU |
| Full Well Capacity | 25,395 electrons | 101,581 electrons |

In another embodiment, the performance of an imaging system may be characterized in accordance with NEI to determine the mean level of input illumination that substantially equals the rms noise floor of the imaging system in darkness. For example, the example imaging system described above for the mean-variance curve characterization may also be characterized using NEI techniques.

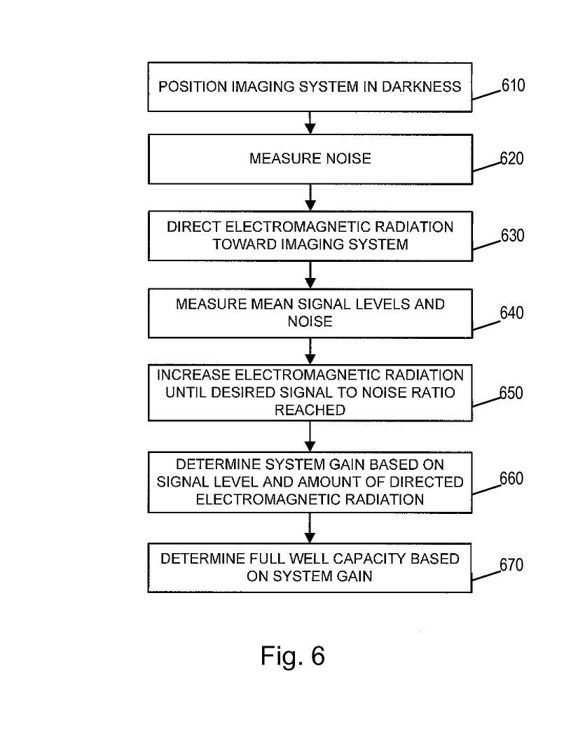

FIG. 6 illustrates a process of performing an NEI characterization of an imaging system in accordance with an embodiment of the disclosure.

To perform an NEI characterization, an image capture component of an imaging system may be initially positioned in total darkness (block 610) as similarly discussed with regard to previous black 510. While the image capture component is positioned in darkness, the aggregate noise floor (e.g., dark current, 1/f noise, reset noise, or other appropriate noise designations) of the imaging system may be the only signal present. Thus, the digital output of the imaging system may be measured under these conditions to obtain a representation of the rms dark noise (e.g., a baseline noise value), for example in ADUs (block 620). For example, a 12 bit A/D converter may incorrectly indicate 5.675 counts of rms A/D noise in darkness.

In block 630, a source of electromagnetic radiation (e.g., an infrared source in one embodiment) may direct a known amount of electromagnetic radiation toward the imaging system such that the imaging system output increases and is larger than the inherent noise floor previously measured in block 620. In one embodiment, a light emitting diode (LED) or a laser diode may be used as the electromagnetic radiation source due to their repeatability and ease of control over white light sources. Other electromagnetic radiation sources may be used in other embodiments.

In block 640, the noise provided by the imaging system may be measured along with mean signal levels while receiving the directed electromagnetic radiation, for example in ADUs. As a result, the measured ADUs may increase in response to the directed electromagnetic radiation. The electromagnetic radiation may be increased until a specified imaging system signal to noise ratio is measured (block 650). For example, in one embodiment, the electromagnetic radiation may be increased until the signal to noise ratio is approximately equal to 1. In the case discussed above, 17.79 nW/cm² of 1550 nm infrared radiation may cause an increase in average signal output of 3,500 ADUs.

Table 2 identifies various test parameters and measurements for the sample case discussed above:

TABLE 2

| PARAMETER | VALUE | MEASUREMENT NOTE |
|---|---|---|
| Real Noise Floor | 11.35 ADU | ADUs (counts) in darkness |
| | (rms) | |
| Level of Directed | 17.79 nW/cm² | Increase over dark mean |
| Electromagnetic | (3500 ADUs) | measured using a calibrated |
| Radiation | | optical power meter |
| Wavelength (λ) of | 1550 nm | LED or laser diode |
| Directed | | |
| Electromagnetic | | |
| Radiation | | |
| Fill Factor | 95% | Percent of a sensor pixel |
| | | area that is sensitive to |
| | | light |
| Quantum | 79% | % of absorbed photons at |
| Efficiency | | specified wavelength that |
| | | create signal electrons |
| Integration Time | 33 ms | 30 frames/second |
| Pixel Size | 25 um × 25 | =625 × 10⁻⁸ cm² |
| | um | |

In the example identified in Table 2, 17.79 nW/cm² of electromagnetic radiation is directed toward image capture component 130 which corresponds to 17.79×10⁻⁹ Joules of photon energy are hitting a one square centimeter area of image capture component 130 every second of exposure.

The energy (E) of a single photon at a wavelength (λ) may be determined from the Planck-Einstein equation: E=h*c/λ, where h is Planck's constant (6.626068×10-34 J-sec), c is the speed of light in m/sec (2.998×108 m/sec.), and λ is the wavelength of electromagnetic radiation in meters.

Accordingly, the information in Table 2 may be used to determine the system gain (block 660) and the full well capacity (block 670) for this example as follows:
17.79×10⁻⁹ J/[(6.626068×10⁻³⁴) (2.998×108)/(1550×10⁻⁹)]=1.3877×10¹¹ photons are hitting one square centimeter area of image capture component 130 every second of exposure;
(0.95) (0.79) (1.3877×10¹¹ photons/cm²-sec)=1.041×10¹¹ signal electrons are created per second per square centimeter from the received photons;
(625×10⁻⁸ cm²) (1.041×10¹¹ electrons/cm²-sec)=650,625 electrons are created in each pixel per second;
1/30 (650,625)=21,687 electrons are created per pixel during one integration (frame) time;
The 21,687 electrons caused an increase of 3500 ADUs, so the “system gain” of imaging system 100 is 21,687 electrons/3500 ADUs=6.2 electrons/ADU; and
Assuming a 12 bit A/D converter with a 4096 count range, the full well capacity may be calculated as approximately 25,395 electrons (e.g., 4096 counts×6.2 electrons/ADU=25,395.2).

Using the above-identified NEI data, Table 3 below shows a comparison of real values (e.g., actual performance that would have been perceived if image lag was not present) and calculated values (e.g., perceived performance with image lag present) for an NEI characterization of an example imaging system as discussed:

TABLE 3

| PARAMETER | REAL VALUE | CALCULATED VALUE |
|---|---|---|
| Read Noise (rms) | 11.35 ADU counts | 5.675 ADU counts |
| System Gain | 6.2 electrons/ADU | 6.2 electrons/ADU |
| Full Well Capacity | 25,395 electrons | 25,395 electrons |

By comparing the data in Tables 1 and 3, it is apparent that when image lag is present, neither the mean-variance curve characterization (Table 1) alone nor the NEI characterization (Table 3) alone provides an accurate characterization of the real values associated with imaging system 100 in this example. In one embodiment, the NET characterization may provide more data that is accurate, but neither characterization taken alone would inform a user as to whether the calculated 5.675 ADU counts of rms noise shown in both of Tables 1 and 3 is the inherent noise floor of imaging system 100, or whether it is the noise after being suppressed by the effects of image lag (e.g., temporal filtering).

In one embodiment, information may be used from both the mean-variance curve characterization and the NEI characterization to more accurately characterize imaging system 100 and also determine what, if any temporal filtering is performed by imaging system 100 (e.g., due to intentionally applied digital recursive filtering or unintentional image lag). In particular, the system gain determined from each approach may be used to determine the actual noise of the imaging system.

For example, in the NEI approach, the system gain may be calculated by determining the mean level of electromagnetic radiation that causes the A/D converter to change its mean value by some number of counts. Because such measurements are mean values that do not change with time, they are not impacted by temporal filtering and are therefore accurate whether or not image lag is present. Accordingly, the system gain determined by the NEI approach may be considered to be accurate.

The full well capacity determined by the NEI approach corresponds to the full scale output of the A/D converter (e.g., 4096 counts in this example) multiplied by the system gain. Accordingly, because the system gain may be accurately determined by the NEI approach, the full well capacity may also be accurately determined using the NEI approach.

As shown in Tables 1 and 3, the mean-variance approach and the NEI approach both provided read noise values of 5.675 ADU counts which differs from the real unfiltered read noise value of 11.35 ADU counts. As such, the read noise values determined by each approach may be considered to be preliminary noise values that are reduced or otherwise skewed by the temporal filtering (e.g., image lag) of the imaging system.

If no temporal filtering was present, then both approaches would have provided identical values for the system gain. However, because temporal filtering is present in the above example, the NEI approach calculated system gain at 6.2 electrons/ADU while the mean-variance approach calculated system gain at 24.4 electrons/ADU. As discussed, the mean-variance system gain in this example is 4 times higher than the actual system gain because the rms noise measurement performed using the mean-variance approach had been attenuated while the mean value gain was unaffected.

The real unfiltered read noise value may be determined based on the measured system gain determined from the NEI approach and from the mean-variance approach. In particular, the unfiltered read noise value may be calculated by multiplying the measured read noise value by a factor determined by taking the square root of the ratio of the mean-variance measured system gain to the NEI measured system gain.

In this example, the ratio of the mean-variance measured system gain (e.g., 24.4 electrons/ADU) to the accurately calculated NEI calculated system gain (e.g., 6.2 electrons/ADU) is approximately equal to 4, which has a square root of 2. Accordingly, the real unfiltered read noise value may be determined by multiplying the measured read noise by a factor of 2 (e.g., the actual read noise of 11.35 ADU counts=2×5.675 ADD counts).

Table 4 below shows the actual values of imaging system 100 in this example:

TABLE 4

| | REAL VALUE WITH | |
|---|---|---|
| | IMAGE LAG IMPACT | VALUE AS IMPACTED |
| PARAMETER | REMOVED | BY IMAGE LAG |
| Read Noise (rms) | 11.35 ADU counts | 5.675 ADU counts |
| System Gain | 6.2 electrons/ADU | 6.2 electrons/ADU |
| Full Well Capacity | 25,395 electrons | 25,395 electrons |

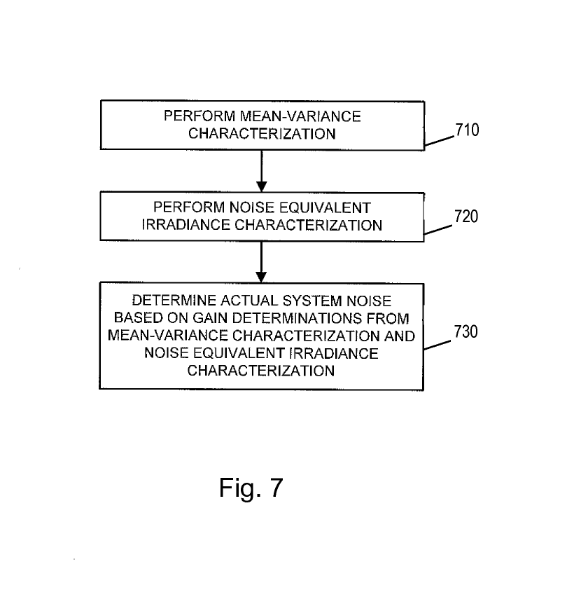

Accordingly, FIG. 7 illustrates a process of performing a composite characterization of an imaging system in accordance with an embodiment of the disclosure. In this regard, the process of FIG. 7 applies the principles of the above discussion to determine the actual noise of the imaging system. In block 710, a mean-variance characterization may be performed as discussed with regard to FIG. 5. In block 720, an NEI characterization may be performed as discussed with regard to FIG. 6. In block 730, the actual noise of the imaging system may be determined based on the gain determinations performed in blocks 710 and 720 using mean-variance and NEI characterizations. As discussed, the actual noise of the imaging system may be calculated by multiplying the measured read noise value by the square root of the ratio of the mean-variance measured system gain (determined in block 710) to the NEI measured system gain (determined in block 720).

In view of the present disclosure, it will be appreciated that image lag and other types of temporal filtering may introduce various undesirable artifacts resulting from scenes containing motion, vibrating image detectors, various beacons and laser designators commonly used in tactical applications, and other causes. However, image lag and temporal filtering may be very useful when imaging static scenes to dramatically improve signal to noise ratios.

Unfortunately, many existing imaging systems include built-in image lag that cannot be disabled. However, using various techniques described herein, such imaging systems may be accurately characterized to determine real performance parameters that describe the actual performance of such systems as they would operate both with and without image lag.

By determining such parameters, more accurate “apples-to-apples” performance comparisons may be made between imaging systems that include permanently enabled image lag, and those that do not include image lag. For example, a first imaging system with permanently enabled image lag may provide output images with noise suppression of 2 times and may appear to exhibit 50 electrons of rms noise. In contrast, a second imaging system without image lag may exhibit 80 electrons of rms noise.

Although the first imaging system with 50 electrons of rms noise may appear to be more sensitive, if a digital recursive filter is activated in the second imaging system (e.g., with no image lag) to provide the same level of filtering as the first imaging system, the resultant noise in the second imaging system may be 40 electrons rms. Thus, the second imaging system may be capable of providing better overall performance and may also be optionally operated without any filtering and thus capable of handling more imaging situations. By determining the actual performance parameters of the first imaging system (e.g., read noise and/or other parameters), the actual performance of the first and second imaging systems may be more accurately compared.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as non-transitory instructions, program code, and/or data, can be stored on one or more non-transitory machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the invention. Accordingly, the scope of the invention is defined only by the following claims.

What is claimed is:

1. A method of performing noise reduction, the method comprising:
receiving a current image of a scene;
comparing the current image and a previously filtered image of the scene to provide a determination of whether the scene is substantially static or substantially dynamic;
selectively applying a temporal filter based on the determination to reduce temporal noise in the current and the previously filtered images;
selectively applying a spatial filter based on the determination to reduce the temporal noise in the current image; and
providing a result image in response to the temporal filter and the spatial filter

2. The method of claim 1, wherein the applying the temporal filter and the applying the spatial filter are further based on user settings to selectively apply either, both, or neither of the temporal filter and the spatial filter.

3. The method of claim 1, further comprising determining a temporal filter weight and a spatial filter weight based on the comparing, wherein the applying the temporal filter is further based on the temporal filter weight, wherein the applying the spatial filter is further based on the spatial filter weight.

4. The method of claim 1, further comprising:
if the scene is substantially static, increasing the applying of the temporal filter and decreasing the applying of the spatial filter;
if the scene is substantially dynamic, decreasing the applying of the temporal filter and increasing the applying of the spatial filter; and
wherein the temporal filter and the spatial filter are applied in parallel with each other.

5. The method of claim 1, wherein:
the temporal filter provides a temporally filtered image;
the spatial filter provides a spatially filtered image; and
the providing the result image comprises combining the temporally filtered image and the spatially filtered image

6. The method of claim 1, wherein:
the current image and the previously filtered image comprise a plurality of pixels;
each pixel has an associated pixel value; and
the comparing comprises:
for each pixel, identifying a set of pixel values within a neighborhood of the pixel,
comparing the sets of pixel values of the current image with the corresponding sets of pixel values of the previously filtered image to provide a plurality of comparison results, and
determining from the comparison results whether the scene is substantially static or substantially dynamic.

7. The method of claim 6, wherein:
the comparing the sets of pixel values comprises:
determining pairwise differences between the pixel values of corresponding pixels in the current and previous neighborhoods,
summing the pairwise differences for each neighborhood to provide one of the comparison results, and
calculating a mean of the comparison results; and
the determining comprises:
determining that the scene is substantially static if the mean is substantially zero, and
determining that the scene is substantially dynamic if the mean is not substantially zero.

8. The method of claim 1, further comprising using the result image from a first iteration of the method as the previously filtered image in a second iteration of the method.

9. The method of claim 1, wherein the current and the previously filtered images are thermal images.

10. An imaging system comprising:
an image detector adapted to capture images of a scene; and
a processing component adapted to execute a plurality of instructions to:
compare a current one of the images and a previously filtered one of the images to provide a determination of whether the scene is substantially static or substantially dynamic,
selectively apply a temporal filter based on the determination to reduce temporal noise in the current and the previously filtered images,
selectively apply a spatial filter based on the determination to reduce the temporal noise in the current image, and
provide a result image in response to the temporal filter and the spatial filter.

11. The imaging system of claim 10, wherein application of the temporal filter and the spatial filter are further based on user settings to selectively apply either, both, or neither of the temporal filter and the spatial filter.

12. The imaging system of claim 10, wherein:
the processing component is adapted to execute the instructions to determine a temporal filter weight and a spatial filter weight based on the comparison;
application of the temporal filter is further based on the temporal filter weight; and
application of the spatial filter is further based on the spatial filter weight.

13. The imaging system of claim 10, wherein:
the processing component is adapted to execute the instructions to:
if the scene is substantially static, increase application of the temporal filter and decrease application of the spatial filter, and
if the scene is substantially dynamic, decrease application of the temporal filter and increase application of the spatial filter; and
the temporal filter and the spatial filter are adapted to be applied in parallel with each other.

14. The imaging system of claim 10, wherein:
the temporal filter is adapted to provide a temporally filtered image;
the spatial filter is adapted to provide a spatially filtered image; and
the result image is a combination of the temporally filtered image and the spatially filtered image.

15. The imaging system of claim 10, wherein:
the current image and the previously filtered image comprise a plurality of pixels;
each pixel has an associated pixel value; and
the processing component is adapted to execute the instructions to compare the current and previously filtered images as follows:
for each pixel, identify a set of pixel values within a neighborhood of the pixel,
compare the sets of pixel values of the current image with the corresponding sets of pixel values of the previously filtered image to provide a plurality of comparison results, and
determine from the comparison results whether the scene is substantially static or substantially dynamic.

16. The imaging system of claim 15, wherein:
the processing component is adapted to execute the instructions to compare the sets of pixel values as follows:
determine pairwise differences between the pixel values of corresponding pixels in the current and previous neighborhoods,
sum the pairwise differences for each neighborhood to provide one of the comparison results, and
calculate a mean of the comparison results; and
the executed instructions are adapted to cause the imaging system to:
determine that the scene is substantially static if the mean is substantially zero, and
determine that the scene is substantially dynamic if the mean is not substantially zero.

17. The imaging system of claim 10, wherein the previously filtered image is a previous result image.

18. The imaging system of claim 10, wherein the current and the previously filtered images are thermal images.

19. The imaging system of claim 10, wherein the logic device comprises a processor and a memory.

20. A method of assessing performance of an imaging system, wherein the imaging system performs temporal filtering and exhibits associated image lag, the method comprising:
performing a mean-variance curve characterization of the imaging system to determine a first system gain;
performing a noise equivalent irradiance (NEI) characterization of the imaging system to determine a second system gain; and
determining an actual noise value of the imaging system based on the first and second system gains, wherein the actual noise value is not reduced by the temporal filtering performed by the imaging system.

21. The method of claim 20, wherein the temporal filtering cannot be selectively disabled by the imaging system.

22. The method of claim 20, wherein the temporal filtering is caused by residual image data retained on sensors of the imaging system.

23. The method of claim 20, wherein the determining the actual noise value comprises:
determining a preliminary noise value of the imaging system from at least one of the characterizations, wherein the preliminary noise value is reduced by the temporal filtering performed by the imaging system; and
multiplying the preliminary noise value by a factor to provide the actual noise value, wherein the factor is based on the first and second system gains.

24. The method of claim 20, wherein the performing the mean-variance curve characterization comprises:
measuring mean signal levels and noise of the imaging system under a plurality of conditions;
determining a mean-variance curve based on the mean signal levels and the noise; and
determining the first system gain based on the mean-variance curve.

25. The method of claim 20, wherein the performing the NEI characterization comprises:
measuring a baseline noise level of the imaging system;
directing a known source of electromagnetic radiation toward the imaging system;
increasing the electromagnetic radiation until a specified signal to noise ratio is reached; and
determining the second system gain based on the amount of electromagnetic radiation provided by the source.

26. The method of claim 20, wherein the imaging system is a thermal camera.
